(19) United States
(12) Patent Application Publication
(10) Pub. No.: US 2005/0072337 A1
(43) Pub. Date: Apr. 7, 2005

(54) Method of refining carbon black char

(75) Inventors: Susan Clarie Powell Wright, Derbyshire (GB); Peter Desmond Callahan, Derbyshire (GB); Martin Gregory, Derbyshire (GB)

Correspondence Address: VENABLE, BAETJER, HOWARD AND CIVILETTI, LLP, P.O. BOX 34385, WASHINGTON, DC, 20043-9998, US

(73) Assignee: DSL Processing (Europe) Ltd, Sheffield (GB)

(21) Appl. No.: 10/732,465

(22) Filed: Dec. 11, 2003

(30) Foreign Application Priority Data
Oct. 3, 2003 (GB) 0323152.9

(51) Int. Cl. C01B 31/02

(52) U.S. Cl. 106/476

(57) ABSTRACT

A method of refining carbon black char, the method comprising removing particles greater than approximately 1 mm in size from a carbon black char feed.

### FIELD OF THE INVENTION

The present invention relates to methods of refining carbon black char resulting from the pyrolysis of carbonaceous products, and to uses of refined and purified carbon black char, such as a pigment, an ink jet carbon black dispersion or formulation, and an ink jet ink. The present invention extends to apparatus for refining carbon black char.

### BACKGROUND OF THE INVENTION

Passenger cars, trucks, lorries etc wear out many millions of tyres every year. A high proportion (approximately 25% to 35%) of the content of tyres is carbonaceous being derived from carbon black, which is a finely divided form of carbon. The carbon black is added to tyres together with steel wire to reinforce and strengthen the tread and side walls thereof. Scrap tyre material may be decomposed at temperatures typically in the range of between 600° C. and 800° C. This decomposition process is known as pyrolysation, and results in the production of gas, oil, and impure carbon black char which consists of steel wire, fused silica particles, free sulphur, and also other non-carbon elements.

It has been found through analysis, that the carbon black char produced by pyrolysis of carbonaceous materials contains many impurities including metallic salts, which render the material unsuitable for some applications including desk jet and ink jet dispersions, and finished ink jet printer inks. Small quantities of other impurities including various compounds, silica and sulphur, are not desirable in most ink applications because they displace the carbon, which results in a low carbon concentration, which affects the final properties of the ink. Furthermore, these impurities are also more difficult to mill down to acceptable particle sizes than pure carbon which results in extended processing times and, therefore, increased cost in the manufacture of the ink. Another problem involved with using carbon black char made from pyrolysis of scrap tyres is that, the fragments of steel wire, which are produced, have to be removed from the pyrolysis by-product before the carbon black char can be processed in to ink jet printer ink, and ink jet carbon black dispersion.

In contrast to carbon black char recovered from pyrolysis, hydrocarbon-derived virgin carbon black, which is the overwhelming world source of finished black inks and dispersions, has far fewer impurities. However, problems associated with using virgin carbon black in ink dispersions include re-agglomeration of the carbon particles. Re-agglomeration results in poor dispersion of the ink when printing.

In addition, environmental considerations are beginning to force the ink jet industry to search for more environmentally friendly processes and substitute substances, which could be used instead of virgin carbon black. The inkjet industry is moving from solvent to aqueous based systems, and from soluble dyes to pigments. A key disadvantage of using pigments is in stabilising the material so that it does not agglomerate and increase in particle size, which then settle out of solution. This settling of the pigment causes terminal failures in the small channels and nozzle orifices of an inkjet print head.

It is an aim of embodiments of the present invention to provide a method of refining impure carbon black char. In addition, it is an aim to provide a method for producing a pigment derived from impure carbon black char. The impurities from the impure carbon black char may be removed because then the product would be directly saleable into the ink jet industry as an input material for ink jet carbon black dispersions and finished ink jet printer inks. Milling is undertaken to reduce particle size in high concentration ink jet dispersions (typically 15% solids or greater), and this concentration is “let-down” or diluted to approximately 5% solids within the finished ink formulation. Therefore, it would also be advantageous to produce a unique formulation that can be developed to counter agglomeration and foaming in milling and “let-down”, and to improve stability in the storage thereof prior to use and in let-down, and finished inks.

According to a first aspect of the present invention, there is provided a method of refining carbon black char, the method comprising removing particles greater than approximately 1 mm in size from a carbon black char feed.

### SUMMARY OF THE INVENTION

By the term “refining”, we mean that carbon present in the feed is extracted or purified from the feed. Preferably, the particles greater than approximately 1 mm in any dimension, for example, length, width, diameter etc., are separated from the char feed. Preferably, particles which are greater than 1 mm in size are separated as waste, and disposed of. Preferably, the removal of particles greater than 1 mm in size produces a pigment comprising carbon, which is preferably a high purity carbon pigment. Preferably, the pigment comprises carbon black.

Preferably, the pigment comprises at least 50% (w/w) carbon, more preferably, at least 65% (w/w) carbon, even more preferably, at least 80% (w/w) carbon, and most preferably, at least 95% (w/w) carbon. In a preferred embodiment, the pigment comprises at least 98% (w/w) carbon.

Preferably, the carbon black char feed comprises carbon, and may be derived from pyrolysis, preferably from the pyrolysis of a carbonaceous product, for example, a tyre, which may be scrap. Preferably, the carbon black char feed is impure and is contained within pyrolysis by-products. Hence, advantageously, the method is an environmentally friendly way of producing a high purity carbon black pigment from scrap tyres.

Preferably, the method comprises classifying the carbon char feed by particle size. Approximately 10% of a tyre, and about 30% of carbon char derived from pyrolysis of tyres, is steel wire. In addition, a large proportion of the carbon char feed consists of part- or un-pyrolysed materials, for example, steel, rubber, and also compounds of silica, which form glass beads, and fibreglass. The majority of these materials tends to be larger than 1 mm across. Preferably, and advantageously, the method removes these particles greater than 1 mm in size.

Preferably, the method comprises classifying the carbon char feed by size such that at least 50% (w/w) of the feed has a particle size of less than approximately 1 mm. Preferably, the size classification step removes particles larger than 1 mm so that at least 60% (w/w), more preferably 70% (w/w), even more preferably 80% (w/w), and most preferably 90% (w/w), of the feed has a particle size of less than approximately 1 mm.

The particles greater than 1 mm may be removed from the carbon char feed by screening. Preferably, the screening comprises vibration. The screening may comprise use of a locker screen, or the like.

Preferably, the method further comprises the step of magnetically separating impurities from the carbon black char feed. Preferably, the magnetic separation step is carried out directly after the pyrolysis step on the carbon black char feed, preferably before the size classification step. Preferably, the method comprises varying a magnetic field in the vicinity of the carbon char feed to which the magnetic impurities are attracted, thereby separating the magnetic impurities therefrom. Preferably, the magnetic separation step comprises use of a magnetic screen, which screen preferably comprises at least one bar magnet and, preferably, at least one rare earth magnet, to which the metallic materials are attracted.

Preferably, and advantageously, this step removes metallic and other magnetically attractive impurities, for example, fragments of steel wire present in the carbon char feed. Preferably, and advantageously, the carbon black char feed is substantially dry, preferably, comprising a dry powder.

Disadvantageously, known methods for removing magnetic impurities from impure carbon black char comprise reacting them with acid/alkali, which may be weak. Such methods involve the use of hazardous chemicals and take a substantial period of time to allow the chemical reaction to complete. Advantageously, use of a magnetic field in the present invention is a quicker and safer way of removing the magnetic impurities from the carbon char feed, allowing the feed to remain dry which is easier to work with than acid/alkali solutions.

Preferably, the method comprises a second size classification step, which may comprise milling and/or grinding the feed. Suitably, the method comprises removing particles from the feed, which are greater than approximately 800 μm in size, more suitably, greater than 600 μm in size, even more suitably, greater than 400 μm in size. Preferably, the method comprises removing particles from the feed which are greater than 200 μm in size, more preferably, greater than 100 μm in size, even more preferably, greater than 50 μm in size, and most preferably, greater than 20 μm in size.

Preferably, the second size classification step removes particles from the feed so that at least 80% (w/w), more preferably 90% (w/w), even more preferably 95% (w/w), and most preferably 98% (w/w), of the feed has a particle size of less than approximately 800 μm, preferably, less than 600 μm, preferably, less than 400 μm, more preferably, less than 200 μm, more preferably, less than 100 μm, more preferably, less than 50 μm and, most preferably, less than 20 μm. Preferably, the second size classification step takes place in a substantially closed environment, in order to capture fugitive airborne particulate emissions.

Preferably, the method comprises classifying the carbon char feed by density. Suitably, the method comprises removing particles from the feed which have a density greater than approximately 2.0 g/cm³, more suitably, greater than 1.5 g/cm³, and more suitably, greater than 1.2 g/cm³. Preferably, the method comprises removing particles from the feed which have a density greater than approximately 1.0 g/cm³, more suitably, greater than 0.75 g/cm³, and more suitably, greater than 0.5 g/cm³.

The density of purified carbon in the pigment is approximately 0.44 g/cm³, which was calculated by filling a 100 cm³ box with purified carbon pigment which was not compacted, and then weighed.

Preferably, the size classification and the density classification steps are carried out by the same apparatus, such as an Opposed Jet Classifier Mill. Preferably, and advantageously, the size and density classification steps remove part- or un-pyrolysed materials, and compounds of silica. Known methods for refining impure carbon black char do not have a step for removing unpyrolysed materials, such as rubber, fibre glass etc. Preferably, overdense particles are removed from the feed retained in the mill.

Preferably, the method comprises removing sulphur compounds and preferably, metallic salts, from the impure carbon black char feed. Preferably, the carbon black char feed is mixed with water at a ratio in the range of 1:0.5 to 1:1.5. Preferably, the water is deionised, and preferably produces a carbon black slurry.

Preferably, the carbon black/water slurry is maintained at a temperature of at least 50° C., more preferably, 60° C., and most preferably, 70° C.

Preferably, the carbon black/water slurry is maintained at this temperature for at least 15 min, more preferably, at least 30 min, even more preferably, at least 45 min, and most preferably, at least 1 hr.

Preferably, the method comprises a step for removing water from the slurry such that the concentration of water in the resultant slurry is less than approximately 50% (w/w), more preferably, less than 25% (w/w), even more preferably, less than 15% (w/w) and most preferably, less than 10% (w/w). Preferably, the de-watering step is carried out in a centrifuge.

Preferably, the method comprises mixing water with the resultant carbon black slurry, preferably at a ratio in the range of 1:0.5 to 1:1.5. Preferably, the water is deionised or demineralised. Preferably, the method comprises dewatering the resultant slurry to produce a high purity carbon black pigment, which comprises a water concentration of less than approximately 50% (w/w), more preferably, less than 25% (w/w), even more preferably, less than 15% (w/w) and most preferably, less than 10% (w/w).

The steps making up the method may be carried out in any order.

According to a second aspect, there is provided a method of producing a pigment comprising carbon black, the method comprising removing particles greater than approximately 1 mm in size from a carbon black char feed, to produce a carbon black pigment.

According to a third aspect, there is provided a pigment comprising carbon black derived from a feed of carbon black char, wherein particles greater than approximately 1 mm in size are removed from the carbon black char feed.

Preferably, the feed comprises impure carbon black char. Advantageously, and preferably, the pigment is derived from recovered waste material or carbonaceous char from pyrolysis, for example, of scrap tyres as opposed to virgin carbon black, which has been cracked from hydrocarbons. In addition, advantageously, the pigment is produced without the use of harmful substances such as acids, alkali and solvents. Therefore, the pigment is produced by a method, which is environmentally friendly both in terms of raw material input and process. In addition, the removal of impurities results in a high purity carbon black pigment, which is comparable to virgin carbon black.

According to a fourth aspect of the present invention, there is provided apparatus for refining carbon black char, the apparatus comprising means to remove particles greater than approximately 1 mm in size from a carbon black char feed.

Preferably, the apparatus comprises feed means for feeding the carbon black char feed to the means for removing particles greater than 1 mm.

Preferably, the apparatus further comprises means to apply a magnetic field to the carbon black char feed, to thereby magnetically separate magnetic impurities therefrom.

Preferably, the apparatus comprises size and preferably, density classification means, which are adapted to classify the feed in terms of size and density, respectively. Preferably, the apparatus comprises washing means adapted to substantially remove sulphur and, preferably metallic salts, from the feed.

According to a fifth aspect, there is provided a composition comprising anti-foaming agent, surfactant, and carbon black, wherein the carbon black is derived from a feed of carbon black char, wherein particles greater than approximately 1 mm in size are removed from the carbon black char feed.

The surfactant may comprise a dispersant.

Optionally, the composition comprises water, preferably at a concentration of approximately 30-60%% (w/w) of the total composition, more preferably 35-55% (w/w), and most preferably 40-50% (w/w) of the total composition.

Preferably, the composition comprises approximately 10-70% (w/w) carbon black, more preferably, 20-50% (w/w) and, most preferably, 25-40% (w/w) carbon black of the total composition.

Preferably, the composition comprises approximately 0.1-10% (w/w) anti-foaming agent, more preferably, 0.15-5% (w/w), and most preferably, 0.2-3% (w/w) anti-foaming agent of the total composition.

Preferably, the composition comprises approximately 1-30% (w/w) surfactant, more preferably, 5-20% (w/w), and most preferably, 10-15% (w/w) surfactant of the total composition.

Suitably, the composition is treated to remove particles, which are greater than 75 μm in size, more suitably, greater than 50 μm in size, and even more suitably, greater than 25 μm in size, from the composition. Preferably, the composition is treated to remove particles, which are greater than 15 μm in size, even more preferably, greater than 5 μm in size, and most preferably, greater than 2 μm in size, from the composition. In a preferred embodiment, particles greater than 0.5 μm are removed from the composition.

Preferably, the particle size of the composition is in the range of approximately in the range of 0.001 μm-1.000 μm, more preferably, approximately 0.010 μm-0.750 μm, and most preferably, 0.060 μm-0.500 μm.

Preferably, the said treating comprises micronising, preferably by a microniser, preferably to produce a dispersion. The micronising means may be a Buhler ZR120+.

The carbon black, pigment, composition, and/or dispersion defined in the above aspects may be used for the manufacture of ink, for example, ink jet and desk jet printer ink, toner etc.

According to a sixth aspect, there is provided an ink formulation comprising the composition defined in the fifth aspect, ethylene glycol, and diethylene glycol.

The ink formulation may be used for the manufacture of an ink jet printer ink.

Optionally, the formulation comprises water, preferably at a concentration of approximately 1-50%% (w/w) of the total formulation, more preferably 10-40% (w/w), and most preferably 25-55% (w/w) water of the total formulation.

Preferably, the formulation comprises approximately 10-80% (w/w) composition defined in the fifth aspect, more preferably, 25-60% (w/w) and, most preferably, 40-50% (w/w) of the composition defined in the fifth aspect of the total formulation.

Preferably, the formulation comprises approximately 1-30% (w/w) ethylene glycol, more preferably, 5-15% (w/w) and, most preferably, 8-12% (w/w) ethylene glycol of the total formulation.

Preferably, the formulation comprises approximately 1-30% (w/w) diethylene glycol, more preferably, 5-15% (w/w) and, most preferably, 8-12% (w/w) diethylene glycol of the total formulation.

All of the features described herein may be combined with any of the above aspects, in any combination.

For a better understanding of the invention, and to show how embodiments of the same may be carried into effect, reference will now be made, by way of example, to the accompanying diagrammatic drawings, in which:

### BRIEF DESCRIPTION OF THE DRAWING

FIG. 1 shows a schematic flow chart for refining impure carbon black.

### DETAILED DESCRIPTION OF PREFERRED EMBODIMENTS

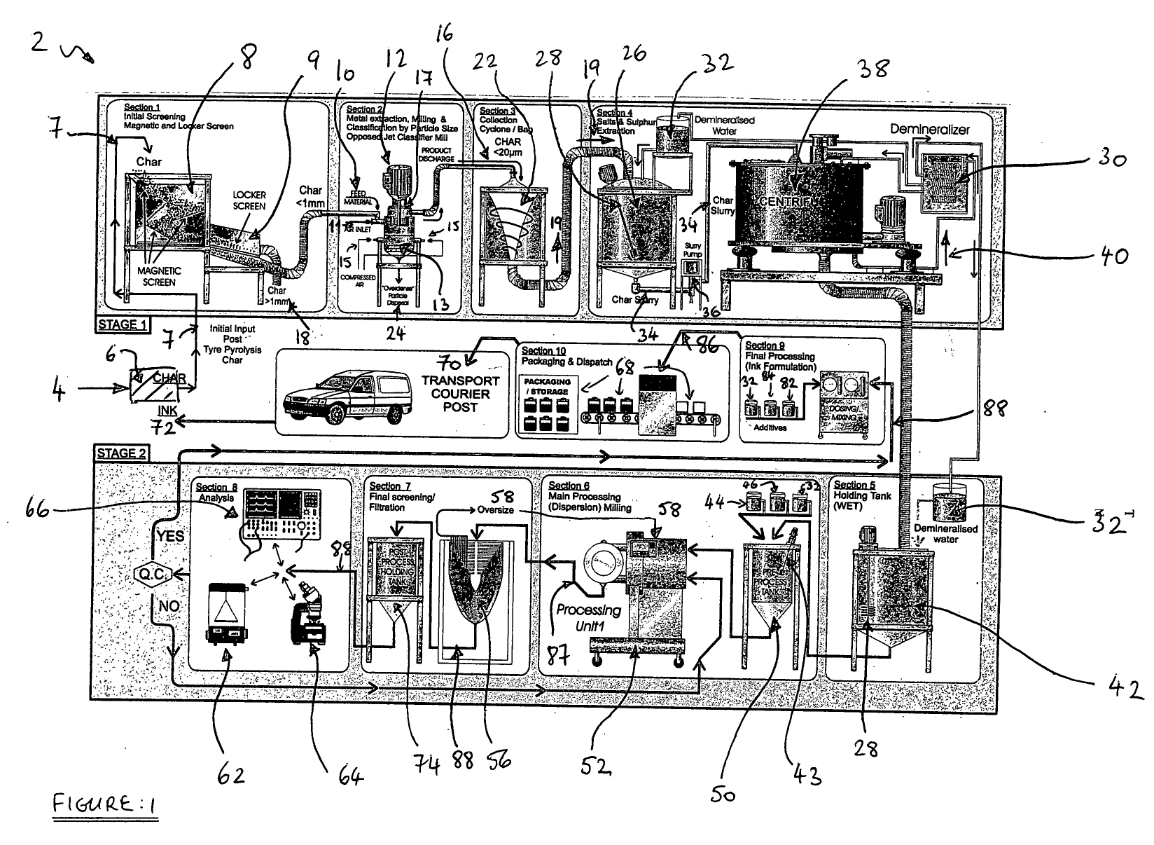

Referring to FIG. 1, there is shown a flow chart of a process 2 for refining impure carbonaceous char in to a dispersion, which can be used to produce ink jet printer ink, and toner. Waste tyres are initially fed 4 in to a pyrolysation unit 6 to produce impure carbon black char 7. The char 7 is then screened using a magnetic screen 8 and a locker screen 9 (section 1). The magnetic screen 8 removes ferrous material impurities 18 from the carbon char, and the locker screen 9 removes particles in the char which are greater than 1 mm in size.

The char particles are then further classified using an Opposed Jet Classifier Mill 12, which extracts smaller particles of metal, and grinds the char down such that the average particle size is no greater than 20 μm (section 2). The char particles are sucked under vacuum out of the Classifier mill 12 by a cyclone 22 (section 3), after which metallic salts and sulphur are extracted, followed by two cycles of dewatering to produce a carbon char slurry (section 4).

Following the dewatering stages, the char slurry is sent to a holding tank 42 where it is mixed with demineralised water to produce a high purity carbon black slurry (section 5). The high purity carbon black slurry is then processed to produce a dispersion, which can be used in the manufacture of paints, ink jet printer inks and toner (section 6). The dispersion is then filtered and sent to a post-processing holding tank 74 (section 7), to await quality control (section 8), and then final processing to produce an ink formulation (section 9). Finally, the products are packaged and then dispatched (section 10). Each stage of the refining process will now be described in detail from Section 1 through to Section 9 shown in the FIGURE.

Referring to Section 1 of the FIGURE, a source of scrap vehicle tyres 4 is initially fed in to a pyrolysation machine 6, which heats the tyres to temperatures in the range of 600° C.-800° C. The tyres decompose producing a source of impure carbon char 7, which consists of steel wire, fused silica particles, free sulphur, and also other non-carbon elements. The carbon char material 7 is variable in size and includes particles as large as 4 mm in size.

The char material 7 is taken from the pyrolysis unit 6 and is fed into a magnetic screen 8 (British Rema, Dronfield, UK), which removes larger metallic particles such as steel wire. The magnetic screen 8 consists of a number of bar and rare earth magnets (not shown) are arranged around a conveyor system. The magnets attract and thereby extract magnetic metals and other ferrous materials out of the carbon char material 7. The magnets are cleaned periodically of the ferrous and other magnetic material, which is collected and safely disposed.

Following removal of the metallic particles, the carbon char is then fed to a vibrating locker screen 9 (British Rema, UK), which removes particles 18 greater than 1 mm in diameter, which are sent to waste.

Referring to Section 2 of the FIGURE, following magnetic separation 8 and vibration locker screening 9, dry material char feed 10 is introduced in to an Opposed Jet Classifier Mill 12 (British Rema, UK) via an airstream 11 through an inlet hopper. Entrained char material 10 passes into the body of the mill 12 and descends in to a grinding chamber 13 at a lower section thereof. Compressed air at approximately 7 bar is supplied to a series of radially disposed nozzles 15 which are located around the periphery of the grinding chamber 13. Particles of feed char 10 are accelerated to a high velocity by a conveying air stream produced by the nozzles 15 and subjected to high intensity impact/attrition grinding.

Ground material having a lower density and therefore entrained in the expanded airstream ascends to a classifier rotor 17 in an upper section of the mill 12. Classification takes place within a vortex generated by the rotor 17 as a result of the interaction between centripetal and air drag forces acting on the char particles.

Product size is determined by control of the speed of the classifier rotor 17. Particles below a cut-off size of approximately 20 μm, and a density of approximately 1 g/cm³, pass through the rotor 17 and exit with the entrained air for recovery in a product collection feed 16 which is passed to section 3 of the FIGURE. Coarse particles 24 above the cut-off size and which are too dense, on which air drag forces have exceeded the centripetal forces migrate to the walls of the mill 12, and descend in to the grinding chamber 13 for further grinding with the incoming feed. High density particles, which are greater than 1 g/cm³, are removed from the mill 12 as waste 24. The milling stage takes place in an enclosed environment.

Referring to Section 3, particles of char 16 produced by the Mill 12, which are less than 20 μm in diameter, and also less than 1 g/cm³, are sucked out of the mill 12 by an Opposed Jet cyclone/bag 22 for collection.

Referring to Section 4 of the FIGURE, the carbon char 19 is fed from the cyclone/bag 22, and is introduced into a mixing tank 26 where it is mixed with demineralised (deionised) water 32, which is produced by a water demineraliser 30. This water has had anions and cations removed via ion exchange. Demineralised water 32 is added to the carbon char 19 at a ratio of approximately 1:1 (% wt) although more water could be used to improve efficiency. The char/water mix is then heated to 70° C. and continuously mixed with a Cole Palmer mixer 28 to aid the absorption of salts and sulphur into the demineralised water 32, thereby creating a carbon char slurry 34.

The slurry 34 is fed by a pump 36 into a centrifuge 38 (Broadbent Decanter Centrifuge, Thomas Broadbent and Sons Ltd, UK), where it is centrifuged until approximately 10% wt of the water remains in the carbon char slurry 34. The char slurry 34 is then returned back to the mixing tank 26 for further washing with more demineralised water 32 for a second time. In the mixing tank 26, the slurry 34 is again heated to 70° C. for approximately 1 hour, and is constantly mixed with the Cole Palmer mixer 28. This second washing step rinses the char slurry 34 again and, following this rinsing process, the char 34 is dewatered in the centrifuge 28 for a second time leaving a high purity carbon black pigment with a moisture concentration of less than 10% wt. The concentration of carbon in the pigment is approximately 90-95% (w/w), and can be used for photocopier toner. The toner can consist of either dry photcopier toner, or liquid toner for use in a laser printer.

Referring to Section 5 in the FIGURE, the high purity carbon black having less than 10% retained moisture is then sent to a holding tank 42. The carbon black pigment is now suitable input material for processing into an ink jet ink dispersion which itself can be used to produce an ink jet ink formulation. Firstly, the high purity carbon black pigment is mixed with demineralised water 32 to achieve a total water to carbon black ratio of 4.18:1. The total water is the sum of retained water from Section 4 plus additional demineralised water 32 added thereto. The water and carbon black are constantly mixed in the holding tank 42 with a mixer 28.

Referring to Section 6 of the FIGURE, following determination of the batch size to be processed, an ink dispersion is made by mixing 87.7% wt of the carbon black/water with 12% wt of a dispersant 44 (Solsperce 44,000, Avecia Pigments and Additives, Manchester, UK), and 0.3% wt of an anti-foaming agent 46 (Rhodoline DF 6681, Rhodia Industrial Specialities Ltd, UK), in a pre-processing tank 50. The dispersion is centrally stirred for a few seconds with a non-vortexing tube mixer 43. In addition, the tube mixer 43 is moved around the pre-processing tank 50 to eliminate any dead space. Two minutes of mixing per litre of premix in the tank 50 ensures appropriate consistency for pumping into a processing unit 52, which consists of a microniser Buhler ZR 120+ (Buhler Ltd, UK).

The carbon char material particles are less than 20 μm in size at this stage and the pre-mix has a consistency to enable the Buhler microniser 52 to achieve an average particle size of 0.060 μm to 0.50 μm. The microniser 52 is configured by Buhler to ensure compatibility with the input formulation. The pre-mix is fed into the microniser 52 at a constant flow rate of 1 litre per minute, although the flow rate could be between 60L/hr-8000L/hr. The microniser 52 has grinding media, which consists of Yttrium-stabilised Zirconium grinding beads, which are 0.3 mm in diameter. The micronising is carried out at the pressure of 0.2 bar, although the pressure could be between 0.1 bar-6 bar. The machine has a cut-out temperature of 40° C.

Referring to Section 7 in the FIGURE, following processing in the Buhler ZR 120+ processing unit 52, the carbon black dispersion is then fed 87 to a membrane filter 56 which filters out any oversized particles that have resisted milling in the Buhler ZR 120+ processing unit 52. The membrane filter 56 filters out particles greater than 0.50 μm in size and these are recycled 58 back to the processing unit 52.

The filtered carbon char dispersion 88 is then sent to a post-processing holding tank 74 and undergoes quality control in a Quality Control area 60 as illustrated in Section 8 of the FIGURE. As part of ongoing quality control, process data is captured in real-time from all stages of the process 2 and assessed centrally to determine conformity with expectations at each stage of the process 2. The batch can be rejected at any stage if it fails to meet the expected quality parameters and returned for reworking, if necessary. In addition, the finished dispersion held in holding tank 74 is subjected to testing for particle size, appearance on substrate medium, and stability.

Two methods of particle size measurements are used. Firstly, a Malvern Zeta Sizer 62 and, secondly, a high magnification power microscope 64. In addition, stability analyses 66 are carried out involving heating and maintaining the product at a temperature of 70° C. for 24 hours.

Following quality control in Section 8, the dispersion 88 is then sent to Section 9 in the FIGURE, where it is used for the preparation of an ink jet ink formulation 86. The formulation consists of 50% (w/w) pigment dispersion 88, 10% (w/w) Ethylene glycol 82, 10% (w/w) Diethylene glycol 84, and 30% (w/w) Deionised water 32.

Referring to Section 10 in the FIGURE, the final ink jet ink formulation is then bottled and packaged 68, and then sent to a despatch area 70. Finished carbon black ink jet ink formulation 72 is then ready for distribution.

Advantages of the refining method of using post pyrolysis tyre char over virgin cracked carbon black are that it helps to solve the problem of what to do with scrap tyres in line with EU Directive. Also, it is an effective use a waste char material that would otherwise be sent to landfill. The method does not use additional virgin cracked carbon black and also saves a lot of oil (at ratio of about 6 tonnes of oil saved per tonne of carbon black produced). The method also has low carbon dioxide emissions (at about 3 tonnes of carbon dioxide per tonne of oil saved, thereby reducing 18 tonnes of carbon dioxide emissions per tonne of virgin carbon black replaced). Also, the method produces an agglomeration resistant material, be it either the pigment, formulation or the dispersion.

Advantages of the method described herein of post-pyrolysis tyre char over other carbon char purification methods are that it uses mechanical and not chemical separation methods to raise carbon purity. In addition, the method uses no acid/alkali or solvents, but uses a variable magnetic field to remove impurities such as steel wire. The method removes particles larger than 1 mm from the feed as these contain greater impurities than smaller particles. The method removes high density particles, as above these contain higher levels of impurity. The pigment produced by the claimed method has applications as an ink dispersion ink jet printer ink and also as a photocopier and laser printer toner.

Advantages of the dispersion described herein over other ink dispersions are that it is aqueous based and no solvents have been used during its manufacture. Also, the dispersion is re-agglomeration resistant.

Advantages of the finished ink jet printer ink described herein are that it has an improved quality, and an increased colour density, i.e. the ink produced is a blacker black. In addition, the ink has a high resistance to bleed, i.e. the black does not bleed into other colours when jetted onto a substrate. The ink is resistant to “feather”, i.e. the ink produces sharp images and lines, which are not feathery. The ink has a high stability, and is resistant to agglomeration therefore particles do not “clump” or join together. Hence, there is a low probability of blocking printer nozzles and orifices. Furthermore, solids remain in suspension, i.e they do not separate from the liquid carrier as quickly as many other inks increasing shelf life.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of refining carbon black char, the method comprising removing particles greater than approximately 1 mm in size from a carbon black char feed.

2. A method as claimed in claim 1, wherein the removal of particles greater than 1 mm in size produces a pigment comprising carbon.

3. A method as claimed in claim 2, wherein the pigment comprises at least 50% (w/w) carbon.

4. A method as claimed in claim 1, wherein the carbon black char comprises carbon which is derived from the pyrolysis of a scrap tyre.

5. A method as claimed in claim 1, wherein the carbon black char feed is impure and is contained within pyrolysis by-products.

6. A method as claimed in claim 1, wherein the method comprises classifying the carbon char feed by size such that at least 50% (w/w) of the feed has a particle size of less than approximately 1 mm.

7. A method as claimed in claim 1, wherein the method further comprises a step of magnetically separating impurities from the carbon black char feed.

8. A method as claimed in claim 1, wherein the method comprises a second size classification step.

9. A method as claimed in claim 1, wherein the method comprises removing particles from the feed, which are greater than approximately 800 μm in size.

10. A method as claimed in claim 8, wherein the second size classification step removes particles from the feed so that at least 80% (w/w) of the feed has a particle size of less than approximately 800 μm.

11. A method as claimed in claim 1, wherein the method comprises classifying the carbon char feed by density.

12. A method as claimed in claim 1, wherein the carbon black char feed is mixed with water at a ratio in the range of 1:0.5 to 1:1.5.

13. A method of producing a pigment comprising carbon black, the method comprising removing particles greater than approximately 1 mm in size from a carbon black char feed, to produce a carbon black pigment.

14. A composition comprising anti-foaming agent, surfactant, and carbon black, wherein the carbon black is derived from a feed of carbon black char, wherein particles greater than approximately 1 mm in size are removed from the carbon black char feed.

15. A composition as claimed in claim 14, wherein the surfactant comprises a dispersant.

16. A composition as claimed in either claim 14, wherein the composition comprises water at a concentration of approximately 30-60%% (w/w) of the total composition.

17. A composition as claimed in claim 14, wherein the composition comprises approximately 10-70% (w/w) carbon black.

18. A composition as claimed in claim 14, wherein the composition is treated to remove particles, which are greater than 75 μm in size.

19. A composition as claimed in claim 14, wherein the particle size of the composition is in the range of approximately 0.001 μm-1.000 μm.

20. A composition as claimed in claim 18, wherein the said treating comprises micronising.
